(19) United States
(12) Patent Application Publication
(10) Pub. No.: US 2008/0167843 A1
(43) Pub. Date: Jul. 10, 2008

(54) One pass modeling of data sets

(75) Inventor: Philip R. Morrison, Sartell, MN (US)

Correspondence Address: OPPENHEIMER WOLFF & DONNELLY LLP, 45 SOUTH SEVENTH STREET, SUITE 3300, MINNEAPOLIS, MN, 55402, US

(73) Assignee: IS Technologies, LLC, Sartell, MN (US)

(21) Appl. No.: 11/650,891

(22) Filed: Jan. 8, 2007

(51) Int. Cl. G06F 17/18

(52) U.S. Cl. 703/2

(57) ABSTRACT

The system and process used for modeling of data sets is improved by achieving one pass modeling which proactively anticipates issues with the model and deals with these issues prior to model formation. The anticipated issues include those involving offending variables, which are initially identified and eliminated so as to avoid any further contribution by those variables. Once offending variables are eliminated, the process then deals with variables having only minimal contributions. To create a simplified and more effective model, these minimal contributors are then eliminated before completion of the model.

### BACKGROUND OF THE INVENTION

The present invention provides a method and system for the one pass modeling of data sets. More specifically, the present invention provides for one pass modeling by eliminating iterative steps that are typically involved in the modeling process, thus allowing modeling to occur in a single pass.

Statistical or predictive modeling occurs for any number of reasons, and provides valuable information usable for many different purposes. Statistical modeling provides insight into data that has been collected, and identifies patterns or indicators that are inherent in the data. Further, statistical modeling of data may provide predictive tools for anticipating outcomes in any number of situations. For example, in financial analysis certain outcomes or responses are potentially predictable, based upon known data and statistical modeling techniques. Similarly, credit analysis could be accomplished utilizing statistical models of financial data collected for multiple subjects. Yet another example, in the product design and development process, modeling of test and evaluation data may be extremely useful in predicting desired causes and affects of certain characteristics, thus suggesting a possible design modifications and changes. Other uses of statistical modeling in industry are very well known, and recognized by those skilled in the art.

Statistical modeling typically follows a process which, unfortunately, can be time consuming and fairly involved. The process begins by appropriately collecting and staging the data to be modeled. Next, a model is fitted based upon the nature of the data, and desired characteristics. In this “fitting” step, coefficients are determined along with other desired characteristics to create a first round model. This first round model is then typically analyzed to determine its accuracy. Based upon the desired characteristics and results, modifications are typically made. More specifically, the person building the model will look for offending variables which cause undesired or inaccurate affects in the data modeling. Next, these offending variables are either changed or removed, and a “remodeling” step is undertaken. As can be imagined, this new model must then similarly be analyzed to determine if any continuing offending variables exist, or to determine if the removal of the aforementioned offending variable achieve the desired result. Where appropriate, remodeling is again undertaken. As can easily be imagined, this process could continue on for some significant period of time until a satisfactory fit is achieved for the model. Obviously, this modeling process utilizes a number of different iterations to effectively achieve the desired result. However, each iteration may be time consuming and process intensive. Consequently, the modeling process is resource intensive, and may take undesirable amounts of time.

In the process of modeling, coefficients are calculated in each pass. This process of calculating coefficients involves an analysis of the contributions of each coefficient, and removal of the minimal contributors. This is carried out each time the model is created using this fitting step.

As mentioned above, the amount of time necessary to create reliable statistical models is one significant issue for the statistical modeling industry. Modeling tends to be time consuming for a number of reasons. Specifically, large amounts of data are typically involved in the modeling process, thus requiring a considerable amount of computing time to generate the desired models. This is not surprising as a considerable amount of data is required to achieve statistical value in the modeling process. While smaller data sets could be used, the statistical value of these smaller data sets becomes suspect. Consequently, there is a natural tradeoff which exists.

In addition to pure processing time, human intervention is typically required with present day modeling techniques. Human intervention is required in the selection of components and/or coefficients throughout the data modeling process. Further, the identification of problems and the appropriate removal of offending variables typically requires human intervention. Further revisions to the model, and the necessary “remodeling” requires operators to examine data sets and make further adjustments. As can be anticipated, this is very tedious and fact specific work, which involves considerable attention to detail. As such, when carried out by human operators, the process is not realistically implemented in a fast manner.

In addition to the complications related to remodeling, the iterative nature of the modeling process, as outlined above, will often considerably add to the time required to effectively complete a statistical model. Each time the model must be redone, or the variables reconfigured, considerable reprocessing is necessary, resulting in additional time being added to overall process. Further, the refitting and reprocessing creates the possibility for an endless loop to occur in the modeling steps. Naturally, this would be a disastrous occurrence, and cause the need to restart the entire modeling process.

In addition to the time and processing power issues discussed above, present day modeling practices also suffer problems with scaling. More specifically, modeling of two separate data sets may result in compatible models, however, the scaling of each model is specific to the data set model. To be applicable on a broader basis, scaling is required so that the model may be applicable to multiple data sets. This scaling has traditionally been achieved through human interaction, which again creates processing and human intervention issues.

In light of the aforementioned issues, it is very desirable to create a modeling process which can be accomplished in a single pass, and which results in models compatible with multiple data sets.

### BRIEF SUMMARY OF THE INVENTION

The present invention achieves one pass modeling by avoiding the multiple iterations previously required in the prior art methods. This process thus provides more efficient modeling, requiring less human intervention and less processing time.

One pass modeling is accomplished by recognizing that offending variables can be easily identified during the coefficient fitting process. Consequently, while producing the desired model, offending variables are identified. In this case, the offending variables are more specifically identified to those variables which would most likely degrade the model. During the coefficient fitting process (i.e., model creation) these variables are removed prior to actual model formation. Consequently, when the resulting model is produced these offending variables no longer exist, thus automatically avoiding the possibility of undue influence by these particular variables.

As discussed above, multiple iterations involving human intervention are typically utilized to identify and correct for offending variables in the existing modeling processes. By dealing with these offending variables at an early stage (before model completion), multiple iterations of the modeling process can easily be avoided.

One of the primary functions of the previously used correction loops has been the elimination of multicolinearity. Utilizing the process of the present invention, issues related to multicolinearity are quickly and easily dismissed by removing those variables exhibiting this characteristic early in the process. Consequently, these variables are not utilized during model creation. Stated alternatively, the sources of multicolinearity are removed prior to the formation of the model itself. Other common sources of offending variables are likewise dealt with in this manner. That is, those sources are eliminated prior to the creation of the model, thus they are not able to adversely effect the model. The other sources of offending variables may include serious outliers and unexpected sign reversals.

It is an object of the present invention to provide a method and system for one pass modeling of data sets. This one pass modeling process eliminates variables at an early stage which are identified as offending variables, thus resulting in an efficiently created model.

It is a further object of the present invention to provide a method and system for modeling of data sets which efficiently reduces human interaction and processing time. Processing time is clearly reduced by avoiding multiple iterations in the model fitting process. Further, steps involving human interaction can be eliminated by automating the modeling process.

### BRIEF DESCRIPTION OF THE DRAWINGS

Further objects and advantages of the present invention will be seen from reviewing the following detailed description, in conjunction with the drawings in which:

FIG. 1 is a flowchart illustrating the prior art method of modeling;

FIG. 2 is a schematic diagram illustrating the modeling system and present invention;

FIG. 3 is a flow chart illustrating the overall methodology for modeling utilized by the present invention; and

FIG. 4 is a more detailed flow chart diagram illustrating the model fitting step of the present invention.

### DETAILED DESCRIPTION OF THE INVENTION

As mentioned, the typical modeling of data can be overly time consuming and labor intensive. The present invention addresses these issues by making a streamlined and more efficient modeling process which can be completed in a single pass.

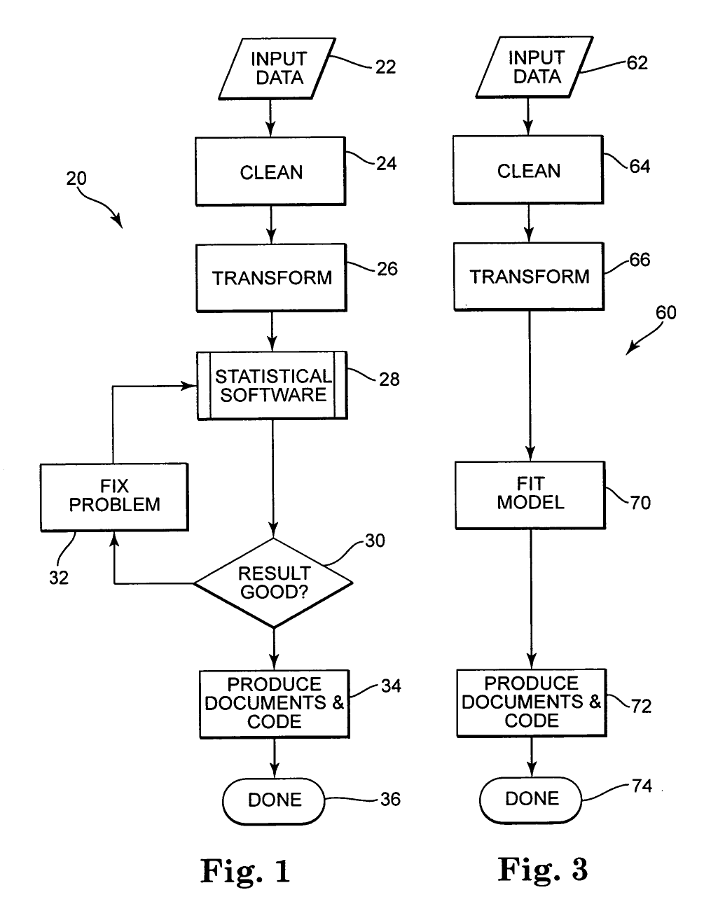

To provide context, one example of an existing modeling process is illustrated in FIG. 1 in flow chart form. More specifically, the modeling process 20 begins with an input data step 22 wherein the appropriate information is loaded into the modeler. Next, the data is “cleaned” in step 24 to deal with any foreseen irregularities or uniqueness in the data. Next, a transformed step 26 is completed which simply transforms data into a format more useable by the modeling process. Next, statistical software 28 is applied. The statistical software 28 performs the actual step of modeling, by a computing coefficients and analyzing variable contributions to the model. As is well understood by those skilled in the art, the modeling step contemplated utilizes the provided data to produce a completed model. This completed model is created using well understood statistical techniques which are applied to the provided data. Following the application of the statistical software step 28, an analysis step 30 is carried out to determine the accuracy/value of the resulting model. This step simply questions whether the resulting model is “good”, or whether problems are inherent. If problems do exist, the modeling process loops to a fix problem step 32 which identifies the potential source of problems, and removes any offending variable or problem coefficient. At this point, because the offending variable or coefficient has now been removed, the process then loops back to the statistical software application 28 and is required to recalculate the model. As can be anticipated, this new model is slightly different from the previous one due to the elimination of the offending variables, etc. At this point, the process will again move to the results analysis step to determine whether the “refit” model is valid or appropriate. As can be anticipated, the “fix problems” loop can continue for an undefined number of times, until a feasible model is created.

Once the analysis step determines that the most recent model is acceptable, the process then moves to the production step 34. At this point appropriate documents and a code is prepared/produced to subsequently implement the necessary process in other situations. More specifically, the documents and code which are prepared to relate to the development of servable code which can be used to analyze additional data sets and apply the recently created model.

As illustrated in FIG. 1, the inherent complication with this modeling process involves the analysis and fixing loop, which can involve many potential steps. Naturally, it is most efficient for fix problem 32 to make relatively small adjustments. This allows for changes to deal with the particular problems without compromising the efficiency of the model. This necessarily increases the number of iterations however, thus increasing the overall number of steps. Again, to achieve each of these repeated steps requires time and processing power.

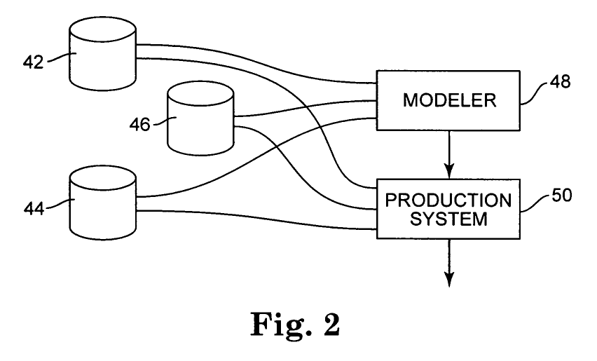

Referring now to FIG. 2, a schematic illustration is shown illustrating one embodiment of the modeling system. As illustrated, a number of data sources, 42, 44 and 46 are shown, each accessible by statistical modeler 48. Statistical modeler 48 provides an output model to a production system 50 for further use. As can be anticipated, production system 50 could take many forms and make use of the data model for many different purposes. Production system 50 also has access to first data source 42, second data source 44 and third data source 46. Production system 50 typically produces its output in many different forms, which may include reports, response to inquiries, data bases, etc.

Referring now to FIG. 3, a flowchart is shown which illustrates one embodiment of the modeling process of the present invention. More specifically, one pass modeling process 60 is illustrated, which begins with a data collection step 62. Once received, the data is then cleaned in cleaning step 64. Next, transformations are accomplished in transform step 66, so that the data can be appropriately processed. Following these preliminary steps, the present process moves to the modeling step 70. This will be further described below. Modeling step 70 inherently produces a reliable/useable model in a single modeling step, thus avoiding the possibilities for unnecessary loops or iterations throughout the process. Next, documents and appropriate code are produced in documents step 72. Upon the completion of documents and code, the modeling step is then completed, at which time the code may be provided to further systems for their potential use. For example, the code may b used by other systems to apply the model to different sets of data, thus providing a predictive tool which provides valuable insight.

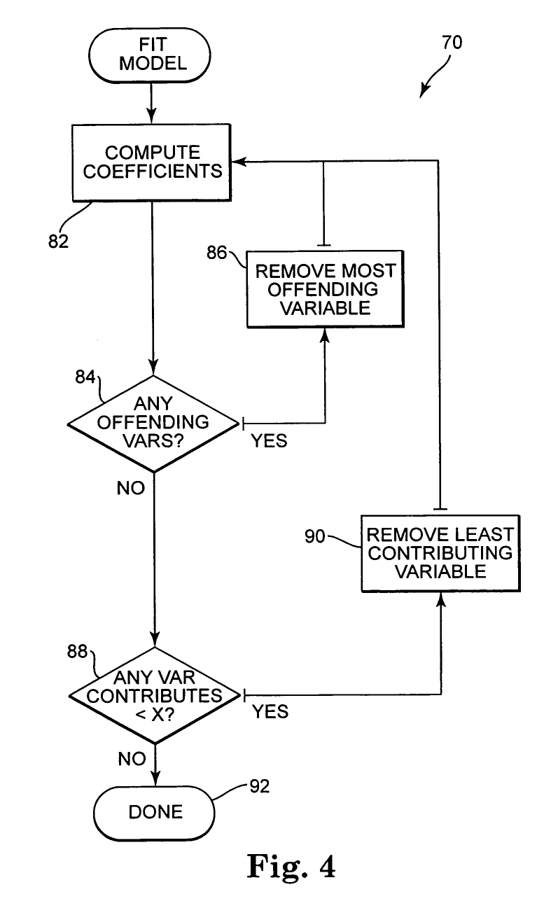

Referring now FIG. 4, a more detailed flowchart is provided, outlining the steps involved in fit model step 70 shown in FIG. 3. Fit model step 70 begins by first computing applicable coefficients for the model, at step 82. Next, the coefficients and existing “draft” model is analyzed to determine if any offending variables are utilized. If offending variables are identified, these offending components are then removed at removal step 86. The modeling system can then regenerate appropriate coefficients at computation step 82. At this point in the overall modeling process, the “recomputation” of coefficients is easily achieved, since the complete model has not yet been formed. Outlined in more detail below are specific examples of potentially offending variables which are typically involved in offending variable analysis step 84.

Referring again to the process of FIG. 4, if no offending variables are identified, the process moves to variable contribution analysis 88 to determine if any variables exist which are contributing negligible affects to the overall model. Since the affects of any identified models are relatively small, they can easily be removed at this point. This removal is achieved at the remove least contributing variable step 90. Following the removal at step 90 of the least contributing variables, the coefficients can again be easily recomputed at coefficient computation step 82. Following the computation of these coefficients, the offending variable analysis 84 and variable contribution analysis 88 can then be completed to determine whether all variables are making contributions appropriate for the desired model. At this point, the model is output at completion step 92 for use by subsequent systems.

Referring again to FIG. 3, the completed model is provided by completion step 92 for use by code generation step 72. In this process, appropriate documentation and code is produced for the recently generated model. Again, the documentation and code is usable by subsequent systems for various purposes depending on the nature of the model. The code produced is fully servable, thus capable of easy implementation in appropriate applications.

One advantage of the process outlined in FIGS. 3 and 4 is the ability to produce models utilizing very little human interaction. Typically, the analysis and adjustment steps of prior modeling systems have been carried out by human interaction. While this does allow for subjective judgment regarding the use of particular coefficient values and the appropriate inclusion of various variables, it is time consuming and often involved. In many instances, an individual modeler (human being) will be required to review and evaluate multiple models during a period of time. Since each model is unique, this requires a complete understanding of the model being analyzed and the necessary adjustments. Once adjusted, a new model must then be created based upon the adjustments made. Conversely, the system and process outlined in FIGS. 2-4 above can be carried out in an entirely automated fashion. That is, the computer is capable of determining if the variables are appropriate for inclusion in the model, while it is being created. Consequently, this totally eliminates the involvement of human operators, and the necessary time required for the manual evaluation steps previously carried out. Further, the process of the present invention will eliminate the level of discretion previously allowed in modeling tasks.

As mentioned above, certain types of variables are classified as offending variables in the method of the present invention. Initially, any variables exhibiting multicolinearity are identified at this fairly preliminary step in the modeling process, and removed from the model. Consequently, the system proactively anticipates and deals with any potential for multicolinearity to negatively influence the model. Additional offending variables may be those exhibiting serious outlier influence (i.e., those with considerable stray data points). Another possibility of an anticipated offending variable is one having unexpected sign reversals, thus creating non-uniform data sets.

In addition to the above-mentioned offending variables, the least contributing variable analysis can be achieved by performing various tasks. For example, T-tests can be utilized. Further, a Wald test, likelihood ratio test, or score test could also be utilized to identify these variables.

As is illustrated below, the modeling process of the present invention can be achieved utilizing a single pass process. The actual process of fitting the model does have loops within that specific process, but these are self-contained in the model formation step. Consequently, a completed model is not produced until offending variable analysis, and least contributing variable analysis is completed. At this point, the model is formed. Because the model forming process deals with these potential error sources, subsequent model analysis is unnecessary and not utilized. The resulting process provides a much more efficient modeling technique, which can more quickly carried out and which reduces the amount of human intervention.

What is claimed is:

1. A method for one-pass modeling of data segments to provide a predictive model usable as an analytical tool suggestive of an outcome, comprising:
collecting data from a segment and calculating a plurality of model coefficients and variables which will produce a preliminary model for the segment;
identifying offending variables in the preliminary model and removing the most significant offending variable until all offending variables are removed;
identifying variables contributing less than a predetermined contribution amount and identifying a least contributing variable, removing the least contributing variable;
repeat the step of identifying variables contributing less than the predetermined amount, and removing the least contributing variable until all variables contribute above the predetermined amount; and
calculating the predictive model using remaining variables.

2. The method of claim 1 wherein the step of removing the most significant offending variable identifies any variable exhibiting characteristics of multicolinearity.

3. The method of claim 2 wherein the step of completing the model includes creating code to implement the model on a subsequent data segment.

4. The method of claim 1 wherein the step of collecting data includes conditioning the data by scaling the data and removing any irregularities.

5. The method of claim 4 wherein the removal of irregularities involves the removal of outliers in the data.

6. A system for one-pass modeling of data segments to provide a predictive model usable as an analytical tool suggestive of an outcome, comprising:
a distributed data storage system containing multiple data segments;
a modeling system for collecting data from a selected segment in the data storage system and calculating a plurality of model coefficients and variables which will produce a preliminary model for the segment, the modeling system further identifying offending variables in the preliminary model and removing the most significant offending variable until all offending variables are removed, the modeling system subsequently identifying variables contributing less than a predetermined contribution amount and identifying a least contributing variable, removing the least contributing variable, and repeating the step of identifying and removing variables contributing less than the predetermined amount until all variables contribute above the predetermined amount, the system then calculating the predictive model using remaining variables; and
a code generating system for generating code capable of implementing the calculated predictive model using the multiple data segments.

7. The system of claim 6 wherein the modeling system identifies those variable exhibiting characteristics of multicolinearity and removes those variables as offending variables.

8. The system of claim 6 wherein the modeling system identifies those variables which are serious outliers and removes those variables as offending variables.

9. The system of claim 6 wherein the modeling system identifies those variables having unexpected sign reversals and removes those variables as offending variables.

10. The system of claim 6 wherein the modeling system will condition the segment prior to calculating the plurality of coefficients.

11. The system of claim 10 wherein the modeling system will condition the segment by eliminating outliers in the data segment.

12. The system of claim 10 wherein the modeling system will condition the segment by scaling the data segment.

13. A method for one-pass modeling of data segments to provide a predictive model usable as an analytical tool suggestive of an outcome, comprising:
conditioning a data segment by removing irregularities and scaling, thus producing a conditioned segment;
collecting data from the conditioned segment and calculating a plurality of potential model coefficients and variables which may be used to produce a preliminary model for the segment;
analyzing the potential model coefficients and variables and identifying offending variables in the preliminary model;
removing the most significant offending variable and continuing to analyze the remaining potential variables until all offending variables are removed;
identifying variables contributing less than a predetermined contribution amount and identifying a least contributing variable, removing the least contributing variable;
repeat the step of identifying variables contributing less than the predetermined amount, and removing the least contributing variable until all variables contribute above the predetermined amount; and
calculating the predictive model using remaining variables.

14. The method of claim 13 wherein the step of removing the most significant offending variable identifies any variable exhibiting characteristics of multicolinearity.

15. The method of claim 13 wherein the step of completing the model includes creating code to implement the model on a subsequent data segment.

16. The method of claim 13 wherein the removal of irregularities involves the removal of outliers in the data.
